(19) United States
(12) Patent Application Publication
(10) Pub. No.: US 2023/0361420 A1
(43) Pub. Date: Nov. 9, 2023

(54) BATTERY MODULE

(71) Applicant: SK On Co., Ltd., Seoul (KR)

(72) Inventors: Hae Ryong JEON, Daejeon (KR); Kang Gu LEE, Daejeon (KR)

(21) Appl. No.: 17/892,286

(22) Filed: Aug. 22, 2022

(30) Foreign Application Priority Data
May 4, 2022 (KR) 10-2022-0055433

(51) Int. Cl. H01M 50/358; H01M 50/204; H01M 50/271; H01M 50/505; H01M 50/591

(52) U.S. Cl. CPC H01M 50/358; H01M 50/204; H01M 50/271; H01M 50/505; H01M 50/591

(57) ABSTRACT

A battery module includes: a housing having an internal space; a plurality of battery cells accommodated in the internal space; and a cover assembly coupled to at least one side of the housing. The cover assembly includes: a duct member forming a venting flow path along which gas, generated in at least a portion of the plurality of battery cells, is flowable; an end cover including one or more outlets connected to the venting flow path and facing the duct member in a first direction; and a plurality of filters disposed in the venting flow path. The plurality of filters are disposed in a second direction, perpendicular to the first direction.

### CROSS-REFERENCE TO RELATED APPLICATION(S)

This application claims benefit of priority to Korean Patent Application No. 10-2022-0055433 filed on May 4, 2022 in the Korean Intellectual Property Office, the disclosure of which is incorporated herein by reference in its entirety.

### BACKGROUND

### 1. Field

The present disclosure relates to a battery module.

### 2. Description of Related Art

Unlike primary batteries, secondary batteries may be charged with and discharged of electricity, and thus may be applied to devices within various fields such as digital cameras, mobile phones, laptop computers, and hybrid vehicles, and electric vehicles. Examples of secondary batteries include nickel-cadmium batteries, nickel-metal hydride batteries, nickel-hydrogen batteries, lithium secondary batteries, and the like.

Such a secondary battery may be manufactured as a pouch-type battery cell having flexibility or a prismatic or cylindrical can-type battery cell having rigidity, and may be used in the form of a module through electrical connection of a plurality of battery cells. In this case, the plurality of battery cells may constitute a cell stack and may be disposed inside a housing to constitute a battery device such as a battery module or a battery pack.

A battery cell may be ignited when various events occur, for example, when the battery cell reaches the end-of-life stage, when swelling in the battery cell occurs, when the battery cell is overcharged, when the battery cell is exposed to heat, when a sharp object such as a nail penetrates through an exterior material, when an external impact is applied to the battery cell, or the like. Flames or high-temperature gas, emitted from a battery cell, may cause a chain ignition of other adjacent battery cells accommodated inside a battery device. Accordingly, the flames or high-temperature gas, emitted from the battery cell, needs to be appropriately discharged so as not to affect other battery cells.

When the flame generated in the battery device is exposed to the outside, breakage or damage may occur in other elements around the battery device and secondary ignition may subsequently occur in other elements. Accordingly, there is a need for an exhaust structure, capable of effectively discharging gas while preventing flames propagating to the outside.

For example, Korean Patent Registration No. 10-2033101 B1 discloses a battery module in which an anti-exposure channel is provided to prevent flames, generated when battery cells are ignited, from propagating to the outside.

However, in the above-described battery module according to the related art, an overall length or size of a cover frame and a battery module is gradually increased as the anti-exposure channel elongates, resulting in poor space efficiency of the battery module and reduced energy density of the battery module.

### SUMMARY

An aspect of the present disclosure is to provide a battery module having a venting structure, capable of effectively discharging gas while preventing flames from propagating to the outside.

Another aspect of the present disclosure is to provide a battery module having a structure in which a gas discharge path may elongate within a limited space.

Another aspect of the present disclosure is to provide a battery module, capable of effectively removing harmful gas and flames generated in a thermal runaway situation.

According to an aspect of the present disclosure, a battery module includes: a housing having an internal space; a plurality of battery cells accommodated in the internal space; and a cover assembly coupled to at least one side of the housing. The cover assembly includes: a duct member forming a venting flow path along which gas, generated in at least a portion of the plurality of battery cells, is flowable; an end cover including one or more outlets connected to the venting flow path and facing the duct member in a first direction; and a plurality of filters disposed in the venting flow path. The plurality of filters are disposed in a second direction, perpendicular to the first direction.

The duct member may include: a body portion supporting the plurality of filters; and one or more inlets connected to the venting flow path.

The body portion of the duct member may include: a seating portion in which at least one of the plurality of filters is accommodated; and a partition wall protruding toward the end cover in at least a portion of an edge of the seating portion.

One surface of the body portion may oppose the end cover, and the other surface opposite to the one surface of the body portion may oppose the plurality of battery cells. The seating portion may be disposed on the one surface of the body portion.

The edge of the seating portion may form a polygon, and the venting flow path may pass through at least one side, among sides of the polygon.

The edge of the seating portion may include: a first edge on which the partition wall is disposed; and a second edge through which the venting flow path passes.

The body portion may include a protrusion protruding on the second edge to support at least one of the plurality of filters.

The partition wall may be in contact with the end cover.

The one or more inlets may penetrate through the body portion to communicate with the internal space of the housing.

The plurality of battery cells may be stacked in a third direction, perpendicular to the first direction, and the one or more inlets may be disposed along the third direction.

The one or more outlets may be disposed along the third direction.

The one or more inlets may be spaced apart from the one or more outlets in the second direction, and the second direction may be perpendicular to both the first direction and the third direction.

The one or more inlets may include a first inlet and a second inlet. The one or more outlets may include a first outlet and a second outlet. The venting flow path may include a first venting flow path, connecting the first inlet and the first outlet to each other, and a second venting flow path connecting the second inlet and the second outlet to each other. The first venting flow path and the second venting flow path may be separated from each other by a partition wall.

The battery module may further include a busbar electrically connected to the plurality of battery cells.

The battery module may further include an insulating cover disposed between the busbar and the end cover.

The body portion may be disposed between the insulating cover and the end cover, and the inlet may disposed between the busbar and the housing.

The plurality of filters may include different types of filters.

At least one of the plurality of filters may have amorphous pores.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a perspective view of a battery module.

FIG. 2 is an exploded perspective view of a battery module.

FIG. 3 is a perspective view of a battery cell included in a battery module.

FIG. 4 is an exploded perspective view of a cover assembly included in a battery module.

FIG. 5 is a perspective view of a duct member and a filter included in a cover assembly.

FIG. 6 is a view illustrating an example of a venting flow path formed in a cover assembly according to exemplary embodiment.

FIG. 7 is a view illustrating an example of a venting flow path formed in a cover assembly according to exemplary embodiment.

FIG. 8 is a view illustrating an example of a venting flow path formed in a duct member.

FIG. 9 is a view illustrating another example of a venting flow path formed in a duct member.

FIG. 10 is a view illustrating another example of a venting flow path formed in a duct member.

FIG. 11 is a front view of a duct member according to exemplary embodiments.

### DETAILED DESCRIPTION

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the appropriate method he or she knows for carrying out the present disclosure. Therefore, the configurations described in the embodiments and drawings of the present disclosure are merely appropriate embodiments but do not represent all of the technical spirit of the present disclosure. Thus, the present disclosure should be construed as including all the changes, equivalents, and substitutions included in the spirit and scope of the present disclosure at the time of filing this application.

Hereinafter, embodiments of the present disclosure will be described in detail with reference to the accompanying drawings. In this case, it is to be noted that like reference numerals denote like elements in appreciating the drawings. Moreover, detailed descriptions related to well-known functions or configurations will be ruled out in order not to unnecessarily obscure the subject matter of the present disclosure. Based on the same reason, it is to be noted that some components shown in the drawings may be exaggerated, omitted or schematically illustrated, and the size of each component does not exactly reflect its actual size.

Hereinafter, example embodiments in the present disclosure will be described in detail with reference to the accompanying drawings.

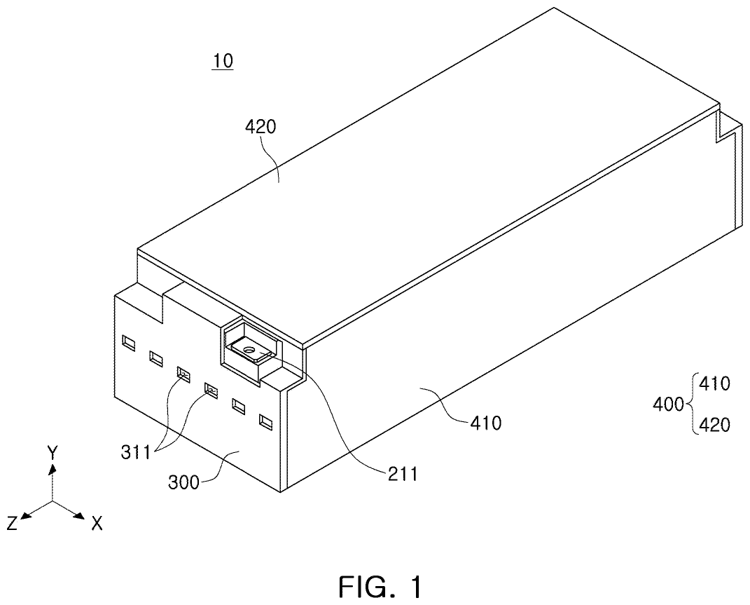

A battery module 10 according to exemplary embodiments will be described with reference to FIGS. 1 to 3.

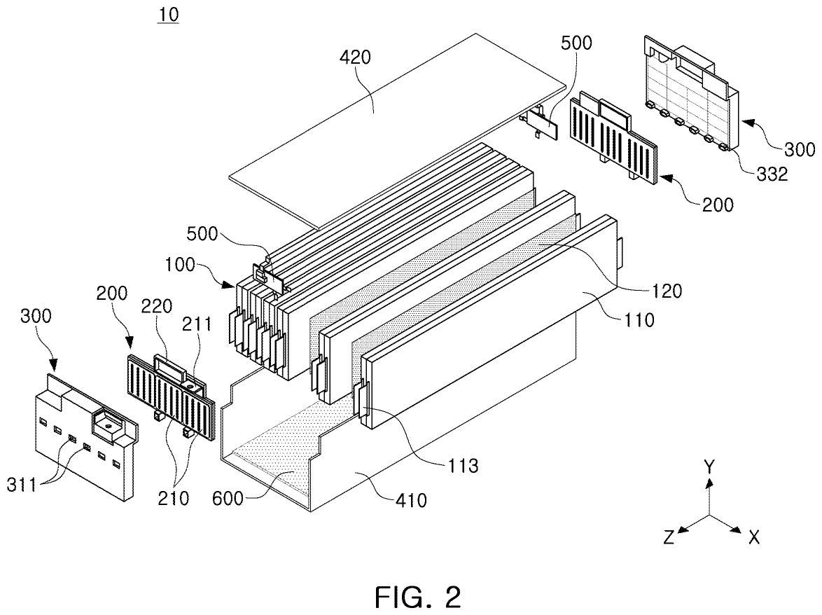

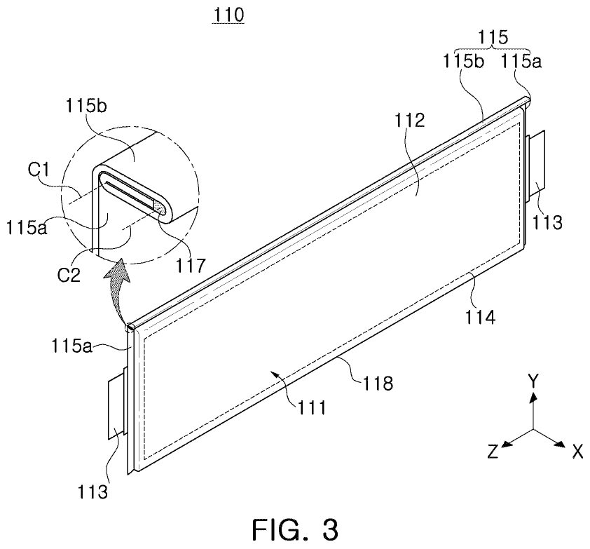

FIG. 1 is a perspective view of a battery module 10. FIG. 2 is an exploded perspective view of the battery module 10. FIG. 3 is a perspective view of a battery cell included in the battery module 10.

The battery module 10 may include a housing 400 having an internal space, a cell stack 100 accommodated in the internal space, a busbar assembly 200 electrically connected to the cell stack 100, and a cover assembly 300 coupled to at least one side of the housing 400.

The cell stack 100 may be accommodated in the internal space of the housing 400, and may include one or more battery cells 110 which may output or store electrical energy.

In exemplary embodiments, the battery cell 110 may be a pouch-type battery cell. Referring to FIG. 3, the battery cell 110 may include an electrode accommodating portion 112, configured in a form in which the electrode assembly 114 is accommodated in the pouch 111, and a plurality of lead tabs 113 electrically connected to the electrode assembly 114 and exposed outwardly of the pouch 111.

The electrode assembly 114 may include a plurality of electrode plates. The electrode plate may include a positive electrode plate and a negative electrode plate. The electrode assembly 114 may be configured in a form in which positive and negative electrode plates are stacked with a separator interposed therebetween. The plurality of positive plates and the plurality of negative plates may each include an uncoated portion, a portion on which an active material is not coated. The uncoated portions may be connected to contact each other to be in contact with each other at the same polarity. The uncoated portions having the same polarity may be electrically connected to each other to be electrically connected to other elements outside the battery cell 110 through a lead tab 113. In the case of the battery cell 110 illustrated in FIG. 3, two lead tabs 113 are illustrated as being led out from the electrode accommodating portion 11 in opposite directions 2, but may be configured to be led out from one side of the electrode accommodating portion 112 in the same direction.

The pouch 111 may surround the electrode assembly 114 and form an exterior of the electrode accommodating portion 112, and may provide an internal space in which the electrode assembly 114 and an electrolyte (not illustrated) are accommodated. The pouch 111 may be formed by folding a sheet of exterior material. For example, the pouch 111 may be configured in a form in which a sheet of exterior material is folded in half and the electrode assembly 114 is accommodated therebetween. The exterior material may be formed of a material which may protect the electrode assembly 114 from an external environment and may include, for example, an aluminum film.

A sealing portion 115 may be formed by bonding an exterior material to an edge of the pouch 111. A thermal fusion method may be used to bond an exterior material for forming the sealing portion 115, but exemplary embodiments are not limited thereto.

The sealing portion 115 may be divided into a first sealing portion 115a, formed in a position in which the lead tab 113 is disposed, and a second sealing portion 115b formed in a position in which the lead tab 113 is not disposed. To improve bonding reliability of the sealing portion 115 and significantly reduce an area of the sealing portion 115, at least a portion of the sealing portion 115 may be formed to have a shape folded once or more than once. For example, the second sealing portion 115b may be folded by 180 degrees along a first bending line C1 and then folded again along a second bending line C2. In this case, an adhesive member 117 may fill a bent portion of the second sealing portion 115b. Accordingly, the second sealing portion 115b may be maintained in the shape, folded twice, by the adhesive member 117. The adhesive member 117 may be formed of an adhesive having high thermal conductivity. For example, the adhesive member 117 may be formed of epoxy or silicone, but exemplary embodiments are not limited thereto.

The sealing portion 115 may not be formed on a surface on which the pouch 111 is folded along an edge of the electrode assembly 114. A portion, in which the pouch 111 is folded along an edge of the electrode assembly 114, will be defined as a folding portion 118 to be distinguished from the sealing portion 115. For example, the pouch-type battery cell 110 may have a form of three-sided sealing pouch 111 in which the sealing portion 115 is formed on three sides, among four sides of the pouch 111, and the folding portion 118 is formed on the other one side.

A form of the battery cell 110 according to the exemplary embodiments is not limited to the above-described three-sided sealing pouch 111. For example, a pouch may be formed by overlapping two different exterior materials, and a sealing portion may be formed on all four sides of the periphery of the pouch. For example, the sealing portion may include a sealing portion on two sides, on which the lead tab is disposed, and a sealing portion on the other two surfaces on which the lead tab is not disposed.

In addition, the battery cell 110 included in the battery module 10 according to exemplary embodiments is not limited to the above-described pouch-type battery cell 110 and may be configured as a cylindrical battery cell or a prismatic battery cell.

Continuing to refer to FIGS. 1 and 2, the battery cells 110 may be stacked in one direction (for example, an X-axis direction of FIG. 2) to constitute at least a portion of the cell stack 100. A stacking direction of the battery cells 110 included in the cell stack 100 may be defined as a “cell stacking direction.”

The cell stack 100 may include a heat insulating member 120 disposed between the battery cells 110 to block heat propagation. The heat insulating member 120 may interfere with or block the propagation of flames or high-temperature thermal energy between adjacent battery cells 110 to prevent chain ignition of the battery module 10. To this end, the heat insulating member 120 may include a material having at least one of properties such as flame retardancy, thermal resistance, thermal insulation, and insulation. For example, the thermal resistance may refer to a property in which a material does not melt even at a temperature of 600 degrees Celsius or more and does not change in shape, and the thermal insulation may refer to a property in which a material has thermal conductivity of 1.0 W/mK or less. For example, the heat insulating member 120 may include at least some among mica, silicate, graphite, alumina, ceramic wool, and aerogel, which may serve to prevent propagation of heat and/or flames. However, the material of the insulating member 120 is not limited thereto, and may be any material as long as it may be maintained in shape even in a thermal runaway situation of the battery cell 110 and may prevent heat or flames from propagating to other adjacent battery cells 110.

A heat dissipation member 600 may be disposed between the cell stack 100 and the housing 400. One surface of the heat dissipation member 600 may be disposed to be in contact with the cell stack 100, and the other surface opposite to the one surface may be disposed to be in contact with the housing 400. The heat dissipation member 600 may be provided as a thermally conductive adhesive. The heat dissipation member 600 may fill a space between the cell stack 100 and the housing 400 to allow heat transfer by conduction to be more actively performed. Accordingly, heat dissipation efficiency of the battery module may be increased.

The plurality of battery cells 110 included in the cell stack 100 may be electrically connected to each other through the busbar assembly 200.

In exemplary embodiments, the busbar assembly 200 may include a busbar 210, electrically connecting one battery cell 110 to another battery cell 110, and a busbar frame 220 supporting the busbar 210.

The busbar assembly 200 may be disposed to face the cell stack 100 in a direction, perpendicular to the cell stacking direction.

The busbar 210 may be formed of a conductive material, and may serve to electrically connect the plurality of battery cells 110 to each other. The busbar 210 may be electrically connected to the lead tab 113 of the battery cell 110. The connection between the busbar 210 and the lead tab 113 may be formed through various welding methods such as laser welding. However, the connection method is not limited to welding, and any connection method may be used as long as two metallic materials may be electrically conducted.

The busbar frame 220 may support the busbar 210 to be stably connected to the battery cell 110. The busbar 210 may be electrically connected to the battery cell 110 while being fixed to the busbar frame 220.

The busbar frame 220 may structurally fix the busbar 210 in an external impact or vibration situation. For example, the busbar frame 220 may include a plastic material being lightweight and having excellent mechanical strength, such as polybutylene terephthalate (PBT) and modified polyphenylene oxide (MPPO), to secure insulation and to structurally support the busbar 210. The busbar 210 may be fixed to the busbar frame 220 in various manners. For example, the busbar 210 may be fixed to the busbar frame 220 by a thermal fusion process or an insert injection molding process.

In exemplary embodiments, the busbar 210 may include a plurality of busbars 210 disposed on the busbar frame 220 to be arranged side by side in the cell stacking direction.

Among the plurality of busbars 210, at least some busbars 210 may have a connection terminal 211 for forming an electrical connection with a device outside the battery module 10. The connection terminal 211 may penetrate through the cover assembly 300 to be exposed to the outside of the battery module 10.

The battery module 10 may further include a sensing module 500 connected to the busbar assembly 200. The sensing module 500 may include a temperature sensor or a voltage sensor. The sensing module 500 may sense a state of the battery cell 110, and may output data on the sensed state to the outside of the battery module 10.

The housing 400 may provide an internal space in which one or more cell stacks 100 may be accommodated. The housing 400 may be formed of a material having predetermined rigidity to protect the cell stack 100 and other electrical equipment, accommodated in the internal space, from external impacts. For example, the housing 400 may include a metal material such as aluminum.

The housing 400 may include a lower case 410 and an upper case 420 coupled to each other. However, the structure of the housing 400 is not limited thereto, and may have any shape as long as it may provide an internal space in which at least one cell stack 100 may be accommodated. For example, the housing 400 may be configured as an integrated monoframe in which the upper case 420 and the lower case 410 are formed to be integrated with each other and front and rear surfaces are open.

The cover assembly 300 may be coupled to one open side of the housing 400. The cover assembly 300 may be provided as a pair of cover assemblies, respectively coupled to opposite sides of the housing 400.

A venting flow path may be formed in the cover assembly 300 to discharge a high-temperature and high-pressure gas, generated in a thermal runaway situation of the battery cell 110, to the outside of the battery module 10.

The venting passage may extend from the internal space of the housing 400 to communicate with an outlet 311 of the cover assembly 300. Gas generated in the cell stack 100 may be introduced into the venting passage through an inlet 332 of the cover assembly 300 to flow, and may be discharged outwardly of the battery module 10 through the outlet 311.

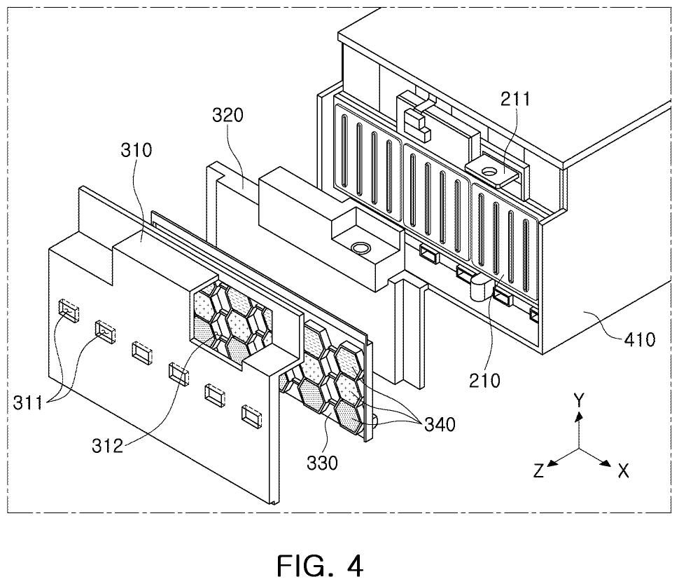

When flames are generated together with a high-temperature gas in a thermal runaway situation of the cell stack 100, the flames may be emitted to the outside of the battery module 10 to cause secondary damage. To prevent the secondary damage, the cover assembly 300 according to exemplary embodiments may be configured such that the venting path elongates, and may include various safety members for filtering a harmful gas and flames. Hereinafter, the cover assembly 300 according to exemplary embodiments will be described in detail with reference to FIGS. 4 to 7.

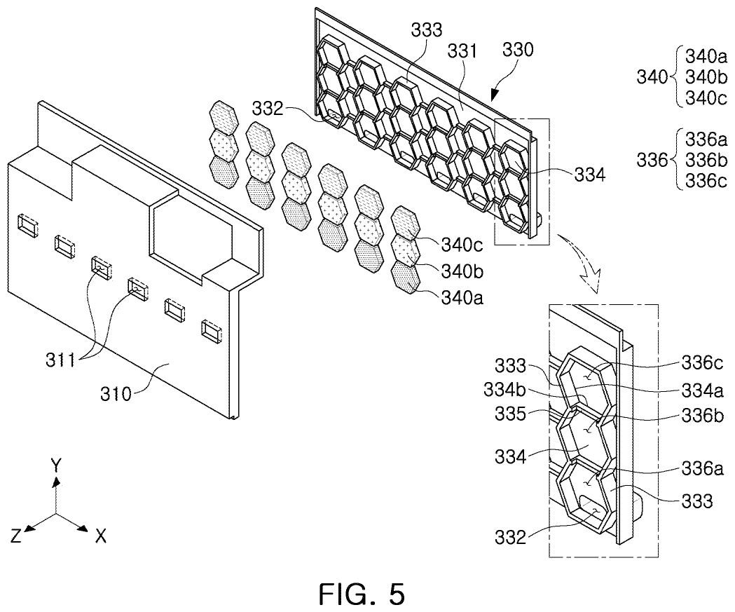

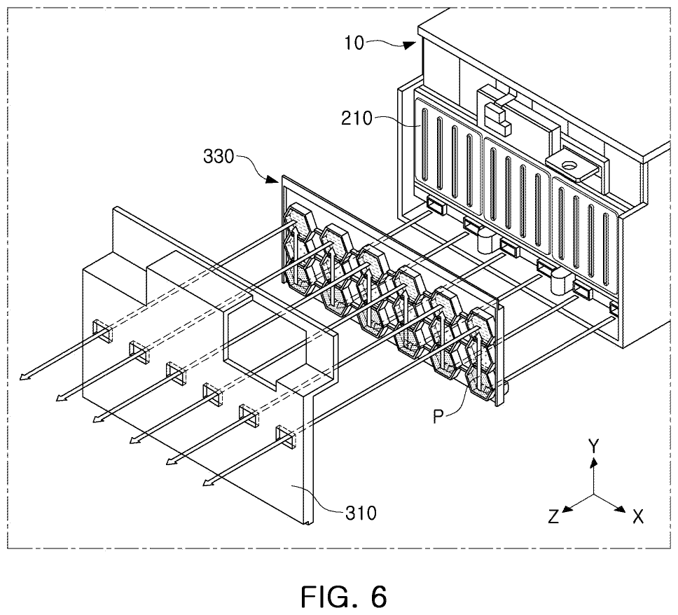

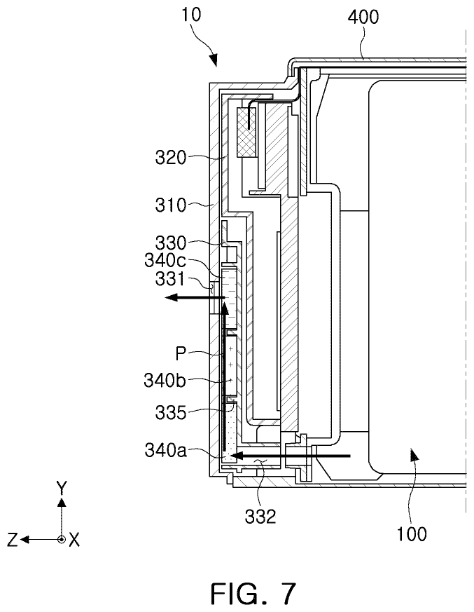

FIG. 4 is an exploded perspective view of the cover assembly 300 included in the battery module 10. FIG. 5 is a perspective view of a duct member 330 and a filter 340 included in the cover assembly 300. FIG. 6 is a view illustrating an example of a venting flow path formed in the cover assembly 300 according to exemplary embodiments. FIG. 7 is a view illustrating an example of a venting flow path formed in the cover assembly 300 according to exemplary embodiments.

The battery module 10 and the cover assembly 300 described in FIGS. 4 to 7 correspond to the battery module 10 and the cover assembly 300 described above with reference to FIGS. 1 to 3, so that overlapping descriptions will be omit

Referring to FIG. 4, the cover assembly 300 may include an end cover 310 covering at least one side of a housing 400, an insulating cover preventing short-circuit between the end cover 310 and a busbar assembly 200, and a duct member 330 forming a venting flow path.

The end cover 310 may be disposed on an outermost side of the battery module 10, and may be configured to protect elements in the battery module 10 from an external environment. To this end, the end cover 310 may include a material having predetermined rigidity. For example, the end cover 310 may include the same material as the housing 400.

One or more outlets 311, through which gas generated from the cell stack 100 may be discharged, may be disposed in the end cover 310. For example, the outlet 311 may be provided in the form of a hole penetrating through the end cover 310.

Although not illustrated in FIG. 4, a blocking layer (not illustrated) may be disposed in the outlet 311 to prevent foreign objects from the outside of the battery module 10. In a thermal runaway situation, the blocking layer (not illustrated) may be deformed or broken to allow the gas, generated from the cell stack 100, to pass therethrough.

A plurality of outlets 311 may be disposed on the end cover 310. For example, as illustrated in FIG. 4, a plurality of outlets 311 may be arranged in the end cover 310 in a direction, parallel to the cell stacking direction.

An opening 312 may be disposed in the end cover 310, and the connection terminal 211 of the busbar assembly 200 may penetrate through the opening 312 to be exposed outwardly of the module.

An insulating cover 320 may be disposed between the end cover 310 and the busbar assembly 200. The insulating cover 320 may prevent short-circuits between the end cover 310 and the busbar 210 or between the duct member 330 and the busbar 210. To this end, the insulating cover 320 may include an insulating material. For example, the insulating cover 320 may be formed of a plastic injection molding material.

The insulating cover 320 may be disposed to oppose the busbar assembly 200 in a first direction (for example, a Z-axis direction of FIG. 4) to prevent the end cover 310 and the duct member 330 from being in physical contact with the conductive busbar 210.

A venting flow path (for example, P of FIGS. 6 to 11), through which gas generated in the cell stack 100 may be exhausted, may be formed in the cover assembly 300. The venting flow path (P of FIGS. 6 to 11) may be defined as at least a portion of a path through which gas generated in an internal space of the module flows to the outlet 311 of the end cover 310.

To reduce a temperature of the high-temperature and high-pressure gas generated in the cell stack 100 and prevent the flames from being discharged outwardly of the battery module 10, it is advantageous that a venting flow path (P of FIGS. 6 to 11) is formed to elongate.

The cover assembly 300 may include a duct member 330, allowing the venting flow path (P of FIGS. 6 to 11) to elongate, such that the venting flow path (P of FIGS. 6 to 11) are formed to be as long as possible.

In example embodiments, the duct member 330 may be disposed to oppose the end cover 310. For example, the duct member 330 may oppose the end cover 310 in the first direction (the Z-axis direction of FIG. 4). In this case, the first direction (the Z-axis direction of FIG. 4) may be parallel to a direction in which the end cover 310 and the cell stack 100 oppose each other. Alternatively, the first direction (the Z-axis direction in FIG. 4) may be perpendicular to the cell stacking direction. However, when the battery cells 110 are stacked in a direction different from that illustrated in FIG. 2, the first direction (the Z-axis direction of FIG. 4) may not be perpendicular to the cell stacking direction.

In exemplary embodiments, the venting flow path may be formed inside the duct member 330 or in a surface of the duct member 330.

The duct member 330 may include a material having a desired rigidity and thermal resistance. For example, the duct member 330 may include a metal, such as aluminum or the like, to structurally withstand a temperature and a pressure of gas flowing through the venting flow path (P of FIGS. 6 to 11).

The duct member 330 may include a body portion 331, constituting a body of the duct member 330 and in which the venting flow path (P in FIGS. 6 to 11) is formed, and one or more inlets 332 communicating with the venting flow path (P of FIGS. 6 to 11).

The inlet 332 may be provided as an additional member, distinguished from the duct member 330, to communicate with the venting flow path (P of FIGS. 6 to 11) of the duct member 330.

One end of the inlet 332 may communicate with the internal space of the housing 400, and the other end opposite to the one end may communicate with the venting flow path (P of FIGS. 6 to 11). For example, when the venting flow path (P of FIGS. 6 to 11) is formed in one surface of the body portion 331 facing the end cover 310, the inlet 332 may be provided in the form of a hole penetrating through the body portion 331 to allow the internal space of the housing 400 and the venting flow path (P of FIGS. 6 to 11) to communicate with each other.

The venting flow path (P of FIGS. 6 to 11) may be configured to communicate with each of the inlet 332 of the duct member 330 and the outlet 311 of the end cover 310. The gas generated in the cell stack 100 may be introduced into the venting flow path (P of FIGS. 6 to 11) through the inlet 332, and may flow to the outlet 311 along the venting flow path (P of FIGS. 6 to 11).

A plurality of inlets 332 may be disposed in the duct member 330. For example, as illustrated in FIG. 5, the plurality of inlets 332 may be arranged in the duct member 330 in a direction, parallel to the cell stacking direction.

In exemplary embodiments, the inlet 332 and the outlet 311 may be disposed to be spaced apart from each other in a second direction (for example, the Y-axis direction of FIG. 4), perpendicular to the first direction (the Z-axis direction of FIG. 4). Accordingly, at least a portion of the venting flow path (P of FIGS. 6 to 11) may extend in the second direction. For example, as illustrated in FIG. 6 or FIG. 7, the inlet 332 of the duct member 330 and the outlet 311 of the end cover 310 may be spaced apart from each other in a direction, perpendicular to the first direction (the Z-axis direction), and at least a portion of the venting flow path P may extend in a direction, perpendicular to the first direction (the Z-axis direction) to communicate with each of the inlet 332 and the outlet 311.

A gas flow path may be bent at least once while the gas, introduced from the internal space of the housing 400 to the inlet 332 in the first direction (the Z-axis direction), flows the venting flow path P. Accordingly, the gas flow path may be increased.

Hereinafter, the venting flow path P formed by the duct member 330 will be described in detail.

In exemplary embodiments, the cover assembly 300 may include a duct member 330 configured to elongate the venting flow path. The duct member 330 may form a space, serving as a venting flow path (P of FIGS. 6 to 11), alone or in combination with other elements of the cover assembly 300.

In exemplary embodiments, a venting flow path (P of FIGS. 6 to 11) may be formed between the duct member 330 and the end cover 310. Referring to FIG. 5, the duct member 330 may include one or more partition walls 333 protruding from the body portion 331 toward the end cover 310. The partition wall 333 may contact the end cover 310 to divide a space between the duct member 330 and the end cover 310 into a plurality of sub-spaces. Each of the sub-spaces may serve as a venting flow path (P of FIGS. 6 to 11) through which gas may flow.

Alternatively, unlike what is illustrated in the drawings, the venting flow path may be formed inside the duct member 330. For example, a plurality of spaces partitioned by one or more partition walls may be formed inside the body portion 331 of the duct member 330, and gas may flow through the spaces to be discharged to the outlet 311 of the end cover 310.

The duct member 330 may include an inlet 332 communicating with the venting flow path. The inlet 332 may communicate with the internal space of the housing 400 by bypassing the insulating cover 320 disposed between the duct member 330 and the busbar assembly 200. For example, as illustrated in FIG. 7, the inlet 332 of the duct member 330 may be disposed between the insulating cover 320 and the housing 400 to communicate with the internal space of the housing 400. Accordingly, gas or flames generated in the cell stack 100 may be introduced into the inlet 332 without being disturbed by the insulating cover 320.

Alternatively, the inlet 332 may penetrate through the insulating cover 320 to communicate with the internal space of the housing 400. In this case, the insulating cover 320 may have a shape surrounding at least a portion of the inlet 332.

The inlet 332 may communicate with the internal space of the housing 400 by bypassing the busbar 210 of the busbar assembly 200. For example, the inlet 332 may be disposed between the housing 400 and the busbar 210, and accordingly, the gas or flames in the internal space of the housing 400 may flow to the inlet 332 by bypassing the busbar 210.

The gas or flames introduced through the inlet 332 may decrease in temperature and energy while flowing along the venting flow path P formed by the duct member 330.

One or more filters 340 may be disposed on the cover assembly 300 to more safely process the gas or flames flowing through the venting flow path P. The one or more filters 340 may be disposed along the venting flow path P, and accordingly, the gas or flames flowing through the venting flow path P may be appropriately processed according to physical and material properties of the filter 340 while passing through the filter 340.

Referring to FIG. 5, the filter 340 may be fixed to the duct member 330. For example, the filter 340 may be fixed to one surface of the body portion 331 of the duct member 330.

A seating portion 334, on which the filter 340 is mounted, may be formed on one surface of the duct member 330.

The partition wall 333 of the duct member 330 may be disposed in at least a portion of an edge of the seating portion 334. Accordingly, a filter accommodating space 336 surrounded by the seating portion 334 and the partition wall 333 may be formed.

The filter accommodating space 336 may be formed to include a plurality of filter accommodation spaces 336. The filter accommodating spaces 336 may communicate with each other to form at least a portion of the venting flow path (P of FIGS. 6 to 11). For example, at least one side of the first filter accommodating space 336a, communicating with the inlet 332, may be opened to allow the first filter accommodating space 336a to communicate with a second filter accommodating space 336b. Other than one side communicating with the first filter accommodating space 336a, another portion of the second filter accommodating space 336b may be opened to allow the second filter accommodating space 336b to communicate with a third filter accommodating space 336c. Accordingly, the gas introduced from the inlet 332 may be discharged to the outlet 311 through the first to third filter accommodation spaces 336a, 336b, and 336c.

The duct member 330 may include a protrusion 335 protruding from one surface of the body 331 to support the filter 340. The protrusion 335 may be disposed between the respective filter accommodating spaces 336 to support the filter 340. A height of the protrusion 335 may be less than a height of the partition wall 333, so that the gas or flames in the venting flow path (P of FIGS. 6 to 11) may flow over the protrusion 335. For example, as illustrated in FIG. 5, the protrusion 335 may be disposed between the first filter accommodation space 336a and the second filter accommodation space 336b or between the second filter accommodation space 336b and the third filter accommodation space 336c. In this case, the protrusion 335 may protrude to a height, less than a height of the partition wall 333. The gas, introduced into the first filter accommodating space 336a from the inlet 332, may flow to the second filter accommodating space 336b over the protrusion 335.

In exemplary embodiments, the filter 340 may not be disposed in at least some filter accommodating spaces 336. For example, the filter 340 may not be disposed in the second filter accommodating space 336b, among the first to third filter accommodating spaces 336a, 336b, and 336c communicating with each other. The filter 340 may be disposed or not be disposed in the filter accommodating space 336, depending on exhaust conditions required for the battery module 10.

The filter accommodating space 336 will continue to be described with reference to FIG. 5.

At least one of the plurality of filters 340 may be accommodated in the seating portion 334 of the duct member 330. The seating portion 334 may be disposed on one surface directed toward the end cover 310 from the body portion 331 of the duct member 330. The seating portion 334 may be provided with a plurality of seating portions 334, and at least one filter 340 may be accommodated in at least a portion of the plurality of seating portions 334. The filter 340 may not be disposed in a portion of the plurality of seating portions 334.

The partition wall 333 may be disposed on at least a portion of an edge of the seating portion 334. The partition wall 333 may protrude from the body portion 331 toward the end cover 310.

The seating portion 334 may be configured in various shapes. For example, as illustrated in FIG. 5, the seating portion 334 may be configured to have a hexagonal edge. However, the shape of the seating portion 334 is not limited thereto. The edge of the seating portion 334 may be configured to form a triangle, a rectangle, or a polygon.

The edge of the seating portion 334 may include a first edge 334a, on which the partition wall 333 is disposed, and a second edge 334b on which a flow of gas is not blocked. In this case, the protrusion 335, protruding to be lower than the partition wall 333 to support the filter 340, may be disposed on the second edge 334b. Alternatively, a partition wall, having a through-hole through which gas or flames may pass, may be disposed on the second edge 334b, unlike the partition wall 333 of the first edge 334a. Alternatively, the second edge 334b may be configured in a flat state having no protruding portion.

The second edge 334b of one seating portion 334 may be brought into contact with the second edge 334b of another adjacent seating portion 334. Since a portion of the first edge 334a is blocked by the partition wall 333 and a portion of the second edge 334b is open to allow gas or flames to flow, the filter accommodating spaces 336 corresponding to the seating portions 334 may communicate with each other through a portion of the second edge 334b. With such a structure, a venting flow path (P of FIGS. 6 to 11) may be formed to penetrate through each of the filter accommodation spaces 336.

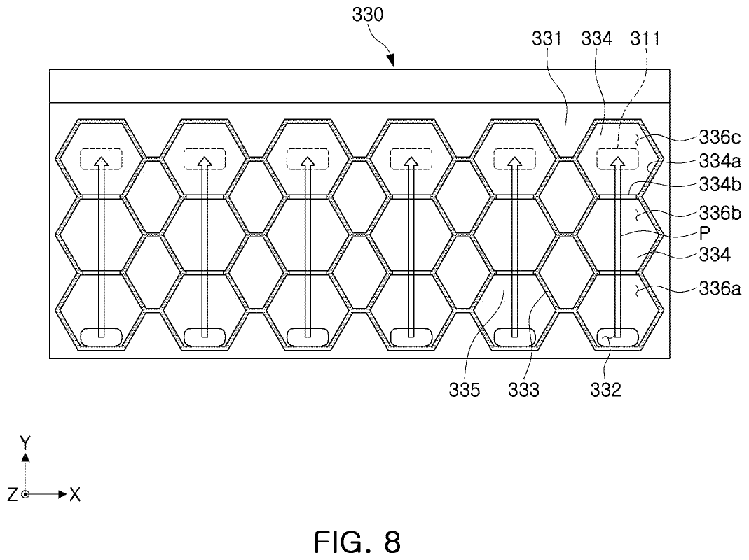

For example, in FIGS. 6 and 7, the filter accommodating spaces 336 are illustrated as communicating with each other in a height direction of the battery module 10 (for example, a Y-axis direction in FIGS. 6 and 7) to form the venting flow path P (the insulating cover 320 is illustrated in FIG. 6). However, this is only an example, and the filter accommodating spaces 336 may communicate with each other in various directions. A detailed description thereof will be provided later with reference to FIGS. 8 to 10.

Continuing to refer to FIGS. 4 to 7, when the venting flow path P is formed between the duct member 330 and the end cover 310, the filter accommodating space 336 of the duct member 330 may have a shape in which one side directed toward the end cover 310 is open. As the duct member 330 and the end cover 310 are coupled to each other, the end cover 310 may cover the open side of the filter accommodating space 336, and a venting flow path P may be formed in a space surrounded by the seating portion 334 of the duct member 330, the end cover 310, and the partition wall 333.

The plurality of filters 340 may be disposed in a space between the duct member 330 and the end cover 310. For example, the plurality of filters 340 may be disposed between the duct member 330 and the end cover 310 on a plane, perpendicular to the first direction (the Z-axis direction).

The plurality of filters 340 may be arranged side by side in one direction. For example, the plurality of filters 340 may be arranged side by side in a second direction (for example, a Y-axis direction), perpendicular to the first direction (the Z-axis direction). The first direction (the Z-axis direction) may be a direction in which the duct member 330 and the end cover 310 face each other. As the plurality of filters 340 are arranged side by side in the second direction (for example, the Y-axis direction), a large number of filters 340 may be disposed in a narrow space between the duct member 330 and the end cover 310.

The gas introduced from the inlet 332 may pass through the filters 340 disposed in each filter accommodation space 336 while flowing along the venting flow path P. In this case, the plurality of filters 340 may include various types of filters 340, each having unique properties.

The plurality of filters 340 may include different types of filters 340. For example, the first filter 340a, the second filter 340b, and the third filter 340c illustrated in FIG. 5 may be different types of filters 340.

Among the plurality of filters 340, at least some filters 340 may include metal-mesh filters including a composite layer or mesh filters including porous metal foam. The porous metal foam may have a porous structure having amorphous pores. The mesh filter may prevent reactive materials (for example, conductive particles generated in a thermal runaway situation) from being discharged outwardly of the battery module 10 and may decrease a temperature of the gas passing through the filter 340 to remove flames. In this case, the mesh filter may include one or more metal materials such as brass, bronze, copper, stainless steel (SUS), and aluminum. Hereinafter, such a filter will be defined as a “first type of filter.”

Among the plurality of filters 340, at least some filters 340 may include a purification filter which may filter harmful gases generated from the cell stack 100. In this case, the purification filter may include at least one of activated carbon (charcoal) or a ceramic material. Hereinafter, such a filter will be as a “second type of filter.”

Among the plurality of filters 340, at least some filters may include cut-off filters preventing external moisture or foreign objects from permeating into the battery module 10. In this case, the cut-off filter may include at least one fiber-based material such as Gore-Tex, Poly Tetra Fluoro Ethylene (PTFE), needle felt, or polyester. Hereinafter, such a filter will be defined as a “third type of filter.”

When a plurality of venting flow paths are formed in the cover assembly 300, one or more filter sets may be disposed in each of the venting flow paths. The filter set may refer to a set of filters allowing gas or flames, flowing into the venting flow path P, to sequentially or simultaneously pass therethrough. For example, FIGS. 5 and 6 illustrate that a plurality of venting flow path P communicate with a plurality of inlets 332 and a plurality of outlets 311, respectively, and a single filter set is disposed in each of the venting flow path P. The first, second, and third types of filters may be combined in the filter set disposed in one of the venting flow paths P. For example, in FIG. 5, a single filter set may include a plurality of filters 340 arranged in the second direction and may be a filter set in which the first, second, and third types of filters are sequentially arranged. However, the arrangement of the filter 340 is not limited to the above description. For example, the plurality of filters 340 disposed in one of the venting flow paths may be a combination of the first and second types of filters, or a combination of the first and third types of filters. Alternatively, the plurality of filters 340 may be provided as the same type of filters (for example, all of the first type of filters).

The filter 340 disposed in each filter accommodating space 336 may have a shape corresponding to a shape of the filter accommodating space 336. For example, when the seating portion 334 is formed to have a hexagonal shape, the filter 340 may be formed to have a shape of a hexagonal pole having a height corresponding to a distance between the seating portion 334 and the end cover 310 and may be accommodated in the filter accommodating space 336.

The filter 340 may be forcibly fitted to the filter accommodating space 336 to be fixed thereto, or may be supported by the protrusion 335 of the duct member 330 to be fixed thereto.

In the battery module 10 according to exemplary embodiments, the plurality of filters 340 may be intensively disposed in a narrow space between the duct member 330 and the end cover 310, and a venting flow path may be configured such that gas and flames introduced through the inlet 332 pass through the filters 340, and thus, space efficiency of the battery module 10 may be significantly increased.

In FIGS. 5 to 7, the venting flow path P is illustrated as being formed in a height direction of the battery module 10, but the venting flow path P formed in the cover assembly 300 according to exemplary embodiments is not limited thereto. Hereinafter, various venting flow paths P formed by the cover assembly 300 according to exemplary embodiments will be described with reference to FIGS. 8 to 10.

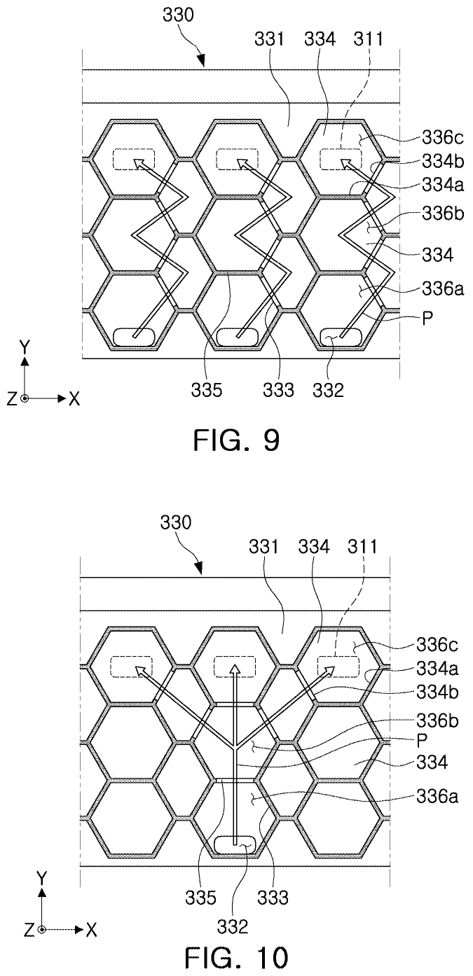

FIG. 8 illustrates an example of the venting flow path P formed in the duct member 330. FIG. 9 illustrates another example of the venting flow path P formed in the duct member 330. FIG. 10 illustrates another example of the venting flow path P formed in the duct member 330. A battery module, a cover assembly, and a duct member 330 described in FIGS. 8 to 10 correspond to the battery module 10, the cover assembly 300 and the duct member 330 described above in FIGS. 1 to 7, respective, so that overlapping descriptions thereof will be omitted.

A venting flow path P, through which gas or flames generated in a cell stack 100 may flow, may be formed between the duct member 330 of the cover assembly (for example, 300 of FIGS. 1 to 7) and the end cover (for example, 310 of FIGS. 2 to 7).

Referring to FIG. 8, a partition wall 333 may be disposed on one surface of a body portion 331, facing the end cover 310, to form a plurality of filter accommodating spaces 336 in which a filter 340 may be accommodated.

In the filter accommodating space 336, a portion in which the partition wall 333 is not disposed (for example, a portion in which a protrusion 335 is disposed, in FIG. 8) may be open. The filter accommodating space 336 may communicate with another filter accommodating space 336 through the open portion. For example, the plurality of filter accommodating spaces 336 may communicate with each other to allow gas and flames to flow, and accordingly, a venting flow path P connected from one filter accommodating space 336 to another filter accommodating space 336 may be formed.

At least one side of the filter accommodating space 336 may be opened in a direction, perpendicular to the first direction (for example, the Z-axis direction), to communicate with another adjacent filter accommodating space 336. In this case, the first direction (the Z-axis direction) may be a direction in which the duct member 330 and the end cover 310 face each other.

In exemplary embodiments, the venting flow path P may be configured as several paths by variously changing the opened portion in the filter accommodation space 336. For example, when the seating portion 334 corresponding to any one filter accommodating space 336 is configured to have a hexagonal shape, a portion of the filter accommodating space 336, corresponding to at least one edge side among six edge sides of the seating portion 334, may be opened, and gas may be flow outwardly through the opened portion.

For example, FIG. 8 illustrates the duct member 330 having a plurality of filter accommodating spaces 336 communicating with each other in a height direction of a battery module 10. Each of FIGS. 9 and 10 illustrates a duct member 330 which may form a path, different from the venting flow path P of FIG. 8.

Among side surfaces of one filter accommodating space 336, one or more side surfaces may be open. For example, as illustrated in FIG. 10, one of the filter accommodating spaces 336b may be configured such that four side surfaces thereof are open. Accordingly, gas introduced into a first filter accommodating space 336a communicating with an inlet 332 may be introduced into a second filter accommodating space 336b having four open side surfaces and may then flow to another filter accommodating space 336c after branching off into three.

According to the direction in which the filter accommodating space 336 is open, the venting flow path P may be bent a plurality of times to be connected to the outlet 311.

Thus, a high-temperature and high-pressure gas, flames, and combustion particles generated in the cell stack (for example, 100 of FIG. 2) may be discharged outwardly of the battery module (for example, 10 of FIGS. 1 and 2) in a safety state because internal energy is reduced while flowing along a venting flow path P formed by connecting the plurality of filter accommodating spaces 336 to each other in various directions.

In exemplary embodiments, the venting flow path P may be configured to have a path parallel to a plane, perpendicular to a direction in which the duct member 330 and the end cover 310 face each other, and bent a plurality of times. According to such a structure, a venting flow path P may be formed as long as possible in a limited space between the cell stack 100 and the end cover 310. For example, to elongate the venting flow path P, a sufficiently long venting flow path P may be formed without increasing a size thereof in a length direction of the battery module 10 (for example, a first direction, a direction in which the cover assembly 300 and the cell stack 100 face each other). Accordingly, the space efficiency of the battery module 10 may be increased, and a high-temperature gas and flames may be stably processed using the long venting flow path P.

In the cover assembly 300, a plurality of venting flow paths P may be formed. For example, a plurality of venting flow paths P may be formed in the cover assembly 300 to be respectively connected to a plurality of inlets 332.

The plurality of venting flow paths P may not overlap each other. For example, a plurality of venting flow paths connected to different inlets may reach different outlets, respectively. For example, as illustrated in FIG. 8 or 9, gases introduced into the two different inlets 332 may flow along two different venting flow paths P, respectively, and may be discharged through the different outlets 311. The two different venting flow paths P may be separated from each other by the partition wall 333 to be prevented from meeting each other. Accordingly, gas emitted by the thermal runaway of a portion of the cell stack 100 may be safely discharged through any one venting flow. Path P and may not propagate to other portions of another adjacent venting path P or the cell stack 100.

However, a single venting flow path communicating with all of the two or more inlets 332 or a single venting flow path communicating with all of the two or more outlets 311 may be configured by variously setting the direction in which the filter accommodating space 336 is open.

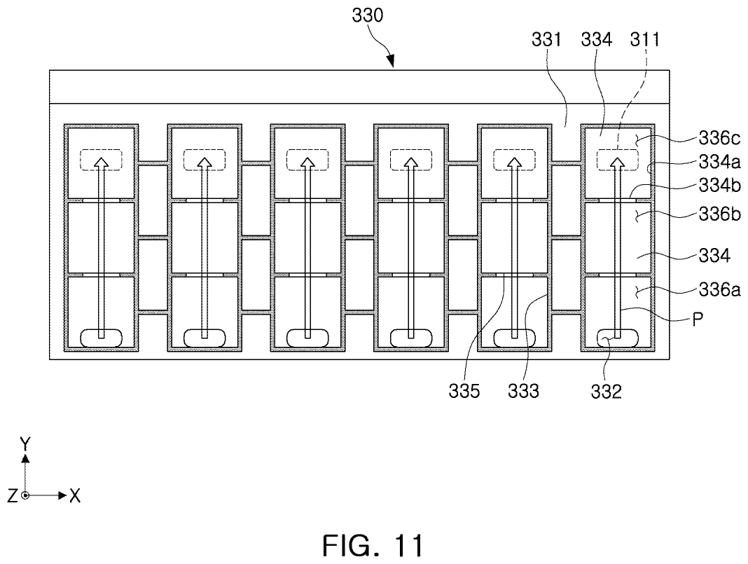

FIG. 11 is a front view of a duct member 330 according to exemplary embodiments.

In FIGS. 8 to 10, an edge of the seating portion 334 of the duct member 330 are illustrated as having a hexagonal shape, but a shape of the seating portion 334 is not limited thereto. For example, as illustrated in FIG. 11, the seating portion 334 of the duct member 330 may be configured such that an edge thereof forms a rectangle.

In this case, the partition wall 333 may be disposed on one edge, among edges forming a quadrangle, and may not be disposed on another edge. Accordingly, the gas or flames may flow from one filter accommodating space 336 to the other filter accommodating space 336 through the edge 334b, on which the partition wall 333 is not disposed, to form a venting flow path P.

The edge of the seating portion 334 may be formed to have various polygonal shapes, in addition to the rectangular shape illustrated in FIG. 11. In this case, the venting flow path P may be configured to pass through at least one side, among sides of the polygon.

Except that the edge of the seating portion 334 has a rectangular shape in the duct member 330 illustrated in FIG. 11, all of the technical features related to the duct member 330 described in FIGS. 1 to 10 may be applied thereto, so that overlapping descriptions will be omitted.

In exemplary embodiments, in the battery module 10, a venting flow path P may be elongated in a module to decrease a temperature of a high-temperature gas generated in a thermal runaway situation and to prevent flames from being emitted outwardly of the battery module 10.

In addition, the battery module 10 may form a venting flow path P, bent a plurality of times between the duct member 330 and the end cover 310, to secure a longer path along which the gas and the flames flow. In this case, the venting flow path P may be configured to extend in a direction, parallel to a plane perpendicular to a direction in which the duct member 330 and the end cover 310 face each other. Accordingly, a venting flow path P, having a length as large as possible without increasing a size of the battery module 10, may be formed.

A plurality of filter accommodation spaces 336, in which the filter 340 may be accommodated, may be disposed between the duct member 330 and the end cover 310. The plurality of filter accommodating spaces 336 may communicate with each other to form a venting flow path P having various paths. Accordingly, the venting flow path P having various paths may be formed in a narrow space between the duct member 330 and the end cover 310.

The gas generated in the cell stack 100 may decrease in temperature and harmful materials may be filtered to be discharged outwardly of the battery module 10 in a safety state while passing through a filter 340 accommodated in the filter accommodating space 336. In addition, the flames generated in the thermal runaway situation may be safely removed while flowing along the venting flow path P.

The plurality of venting flow paths P are configured to not overlap or meet with each other, so that the gas or flames introduced into one venting flow path P may not flow to another venting flow path P. Accordingly, the gas or flames generated in one portion of the cell stack 100 may be prevented from flowing along the venting flow path P and propagating to other portions of the cell stack 100.

As described above, in a battery module according to exemplary embodiments, a venting flow path may be elongated to decrease a temperature of a high-temperature gas generated in a thermal runaway situation and to prevent flames from being discharged outwardly of the battery module.

In addition, the battery module may have a sufficiently elongated venting flow path within a limited space between a cell stack and an end cover.

In addition, the battery module may have a structure in which a venting flow path may be elongated while maintaining an overall module size, so that energy density of the battery module may be further increased.

In addition, the battery module may various form a venting flow path through a duct member which may have various shapes.

In addition, the battery module may allow gas or flames, flowing along a venting flow path, to pass through a filter, so that harmful gases and the flames may be removed.

In addition, a battery module may configure a plurality of venting flow paths, separated from each other, to prevent gas or flames, generated in one portion inside the battery module, from flowing along the venting flow path and propagating to another portion inside the battery module.

While example embodiments have been shown and described above, it will be apparent to those skilled in the art that modifications and variations could be made without departing from the scope of the present invention as defined by the appended claims.

What is claimed is:

1. A battery module comprising:
a housing having an internal space;
a plurality of battery cells accommodated in the internal space; and
a cover assembly coupled to at least one side of the housing,
wherein
the cover assembly comprises:
a duct member forming a venting flow path along which gas, generated in at least a portion of the plurality of battery cells, is flowable;
an end cover including one or more outlets connected to the venting flow path and facing the duct member in a first direction; and
a plurality of filters disposed in the venting flow path, and
the plurality of filters are disposed in a second direction, perpendicular to the first direction.

2. The battery module of claim 1, wherein
the duct member comprises:
a body portion supporting the plurality of filters; and
one or more inlets connected to the venting flow path.

3. The battery module of claim 2, wherein
the body portion of the duct member comprises:
a seating portion in which at least one of the plurality of filters is accommodated; and
a partition wall protruding toward the end cover in at least a portion of an edge of the seating portion.

4. The battery module of claim 3, wherein
one surface of the body portion opposes the end cover, and the other surface opposite to the one surface of the body portion opposes the plurality of battery cells, and
the seating portion is disposed on the one surface of the body portion.

5. The battery module of claim 3, wherein
the edge of the seating portion forms a polygon, and
the venting flow path passes through at least one side, among sides of the polygon.

6. The battery module of claim 3, wherein
the edge of the seating portion comprises:
a first edge on which the partition wall is disposed; and
a second edge through which the venting flow path passes.

7. The battery module of claim 6, wherein
the body portion includes a protrusion protruding on the second edge to support at least one of the plurality of filters.

8. The battery module of claim 3, wherein
the partition wall is in contact with the end cover.

9. The battery module of claim 2, wherein
the one or more inlets penetrate through the body portion to communicate with the internal space of the housing.

10. The battery module of claim 9, wherein
the plurality of battery cells are stacked in a third direction, perpendicular to the first direction, and
the one or more inlets are disposed along the third direction.

11. The battery module of claim 10, wherein
the one or more outlets are disposed along the third direction.

12. The battery module of claim 11, wherein
the one or more inlets are spaced apart from the one or more outlets in the second direction, and
the second direction is perpendicular to both the first direction and the third direction.

13. The battery module of claim 10, wherein
the one or more inlets include a first inlet and a second inlet,
the one or more outlets include a first outlet and a second outlet,
the venting flow path includes a first venting flow path, connecting the first inlet and the first outlet to each other, and a second venting flow path connecting the second inlet and the second outlet to each other, and
the first venting flow path and the second venting flow path are separated from each other by a partition wall.

14. The battery module of claim 2, further comprising:
a busbar electrically connected to the plurality of battery cells.

15. The battery module of claim 14, further comprising:
an insulating cover disposed between the busbar and the end cover.

16. The battery module of claim 15, wherein
the body portion is disposed between the insulating cover and the end cover, and
the inlet is disposed between the busbar and the housing.

17. The battery module of claim 1, wherein
the plurality of filters include different types of filters.

18. The battery module of claim 17, wherein
at least one of the plurality of filters has amorphous pores.
